(19) United States
(12) Patent Application Publication
(10) Pub. No.: US 2016/0147406 A1
(43) Pub. Date: May 26, 2016

(54) METHOD FOR PROVIDING GRAPHICAL USER INTERFACE AND ELECTRONIC DEVICE FOR SUPPORTING THE SAME

(71) Applicant: Samsung Electronics Co., Ltd., Suwon-si (KR)

(72) Inventor: Jongpil Yi, Hwaseong-si (KR)

(21) Appl. No.: 14/937,686

(22) Filed: Nov. 10, 2015

(30) Foreign Application Priority Data
Nov. 25, 2014 (KR) 10-2014-0165198

(51) Int. Cl. G06F 3/0488; G06F 3/0484

(52) U.S. Cl. CPC G06F 3/0488; G06F 3/04842

(57) ABSTRACT

An electronic device, according to certain embodiments of the present disclosure, includes: a display module that displays a plurality of image items; and a processor that, when a swipe gesture input with respect to a specific image item among the plurality of image items is detected, controls the display module to display high level items or low level items of the specific image item. Other embodiments are provided.

### CROSS-REFERENCE TO RELATED APPLICATION(S) AND CLAIM OF PRIORITY

The present application is related to and claims priority from and the benefit under 35 U.S.C. §119(a) of Korean Patent Application No. 10-2014-0165198, filed on Nov. 25, 2014, which is hereby incorporated by reference for all purposes as if fully set forth herein.

### TECHNICAL FIELD

The present disclosure relates to a method for providing a graphical user interface and an electronic device thereof, and more particularly, to a method for providing various graphical user interfaces through the screen, according to the detection of touch input events, and an electronic device thereof.

### BACKGROUND

Recently, with the rapid spread of various electronic devices, the electronic devices have become necessary for modern people. Portable terminals are considered as an example of such electronic devices. The portable terminal provides a variety of images and text through the graphical user interface (GUI) that is provided by the portable terminal, as well as a unique voice communication service and various data transmission services.

### SUMMARY

The electronic device displays a graphical user interface that includes images and text on the screen. However, the user is required to make several inputs in order to perform a desired function because of the limited performance of the functions of the electronic device. This causes an inconvenience to the user and prevents the execution of intuitive functions.

To address the above-discussed deficiencies, it is a primary object to provide a method for providing a graphical user interface and an electronic device thereof in order to reduce the problems above.

In accordance with various embodiments of the present disclosure, an electronic device includes: a display module that displays a plurality of image items; and a processor that, when a swipe gesture input with respect to a specific image item among the plurality of image items is detected, controls the display module to display high level items or low level items of the specific image item.

In accordance with various embodiments of the present disclosure, a method for displaying a graphical user interface in an electronic device includes: letting a display module display a plurality of image items; and letting a processor, when a swipe gesture input with respect to a specific image item among the plurality of image items is detected, control the display module to display high level items or low level items of the specific image item.

The electronic device, according to various embodiments of the present disclosure, displays an image including the information desired by the user according to the detection of a swipe gesture input. This allows the user to carry out a desired function more conveniently and more quickly.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an electronic device according to various embodiments of the present disclosure;

FIG. 2 illustrates a graphical user interface of an electronic device according to various embodiments of the present disclosure;

FIG. 3 illustrates a graphical user interface of an electronic device according to various embodiments of the present disclosure;

FIG. 4 illustrates a graphical user interface of an electronic device according to various embodiments of the present disclosure;

FIG. 5 illustrates the operation of providing a graphical user interface of an electronic device according to various embodiments of the present disclosure;

FIG. 6 illustrates the operation of providing a graphical user interface of an electronic device according to various embodiments of the present disclosure; and

FIG. 7 illustrates the operation of providing a graphical user interface of an electronic device according to various embodiments of the present disclosure.

### DETAILED DESCRIPTION

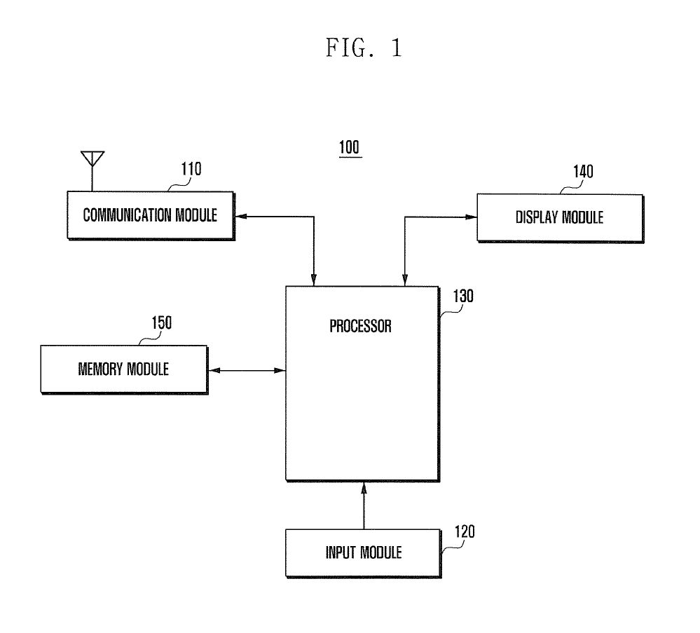

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. Hereinafter, various embodiments of the present disclosure will be described in detail with reference to the accompanying drawings. It should be noted that the same elements will be designated by the same reference numerals although they are shown in different drawings. Further, a detailed description of a known function and configuration that can make the subject matter of the present disclosure unclear will be omitted. Hereinafter, it should be noted that only the descriptions will be provided that help understanding the operations provided in association with the various embodiments of the present disclosure, and other descriptions will be omitted to avoid making the subject matter of the present disclosure rather unclear.

FIG. 1 is a block diagram of an electronic device 100, according to various embodiments of the present disclosure. The electronic device 100 includes a communication module 110, an input module 120, a processor 130, a display module 140, and a memory module 150.

An electronic device, according to certain embodiments of the present disclosure, is a device with a communication function. For example, the electronic device includes at least one of a smart phone, a tablet personal computer (PCs), a mobile phone, a video phone, an e-book reader, a desktop PC, a laptop PC, a netbook computer, a personal digital assistant (PDA), a portable multimedia player (PMP), a MP3 player, a mobile medical device, a camera, a wearable device (e.g., head-mounted-device (HMD) such as electronic glasses, electronic clothes, an electronic bracelet, an electronic necklace, an electronic appcessory, an electronic tattoo, or a smart watch).

The electronic device 100, according to various embodiments, is a smart home appliance with a communication function. The smart home appliance as an example of the electronic device includes at least one of a television, a digital video disk (DVD) player, an audio, a refrigerator, an air conditioner, a vacuum cleaner, an oven, a microwave oven, a washing machine, an air cleaner, a set-top box, a TV box (e.g., SAMSUNG HOMESYNC™, APPLE TV™, or GOOGLE TV™), a game console, an electronic dictionary, an electronic key, a camcorder, and an electronic picture frame.

According to certain embodiments, the electronic device includes at least one of various medical devices such as a magnetic resonance angiography (MRA) scanner, a magnetic resonance imaging (MRI) scanner, a computed tomography (CT) scanner, a scanner, an ultrasonograph, or the like, a navigation device, a global positioning system (GPS) receiver, an event data recoder (EDR), a flight data recoder (FDR), a vehicle infotainment device, an electronic equipment for ship (for example a ship navigation device and gyro-compass and the like, avionics, a security device, a head unit for vehicle, an industrial or household robot, ATM (automatic teller machine) in banking facilities or point of sales (POS) in stores.

According to certain embodiments, the electronic device includes at least one of furniture or a part of a building/structure, an electronic board, an electronic signature receiving device, a projector, and various types of measuring devices (for example, a water meter, an electric meter, a gas meter, a radio wave meter and the like) including a camera function.

The communication module 110 supports a mobile communication service of the electronic device 100. The communication module 110 forms communication channels with the mobile communication system. To this end, the communication module 110 includes a radio frequency transmitter that up-converts and amplifies the frequency of a transmitted signal, and a receiver that low-noise-amplifies a received signal and down-converts the frequency thereof.

The communication module 110, according to certain embodiments of the present disclosure, communicates with an input interface 200 through wireless communication or wired communication. In certain embodiments, the wireless communication, for example, include at least one of wireless fidelity (Wife), BLUETOOTH (BT), near field communication (NFC), a global positioning system (GPS), or cellular communications (e.g., LTE, LTE-A, CDMA, WCDMA, UMTS, WiBro, GSM, or the like). In certain embodiments, the wired communication, for example, includes at least one of a universal serial bus (USB), an high definition multimedia interface (HDMI), recommended standard 232 (RS-232), or a plain old telephone service (POTS).

The communication module 110, according to certain embodiments of the present disclosure, transmits a signal for requesting data (e.g., audio data or the like) to an external server (not shown). The communication module 110 receives data from the external server in response to the transmitted request signal. For example, when an input event for playing an audio file is detected, the communication module 110 transmits a signal for requesting the audio file corresponding to an audio item to the external server. The communication module 110 receives the audio file from the external server in response to the transmitted request signal.

The communication module 110 receives, from the external server, the information (e.g., recommendation data of image items, preference data of image items, or the like) related to an image item on which the input event is detected.

The input module 120 includes a plurality of input keys and function keys to receive number information or text information and to configure various functions. The function keys include direction keys, side keys, and shortcut keys, which are configured to execute specific functions. In addition, the input module 120 creates key signals related to a user's configuration and the function control of the electronic device 100, and transfers the same to the processor 130.

The processor 130 controls the power supplied to each element of the electronic device 100 to thereby support an initialization process, and when the initialization process is completed, the processor 130 controls each of the elements.

The processor 130, according to certain embodiments of the present disclosure, detects a selection input event with respect to one of image items that are displayed on the screen. In certain embodiments, the image items are thumbnail images or icons, which include text data or image data. In certain embodiments, the selection input event is an input signal that is received from external objects (e.g., a human body, an electronic pen, external devices, or the like).

The image items, according to certain embodiments, belong to specific levels in a level-based layer structure comprised of a plurality of items. For example, the layer structure “A” is comprised of the image item a₁ that belongs to the highest level, the image item a₂ that belongs to a lower level than the image item a₁, and the image item a₃ that belongs to a lower level than the image item a₂. The display module 140 displays the image item a₁ that is the highest level in the layer structure “A.” For another example, the image items, which are displayed on the screen in accordance with certain embodiments, is the image items that correspond to the layer structure “A,” the image items that correspond to the layer structure “B,” or the image items that correspond to the layer structure “C.”

When a swipe gesture input is detected with respect to a specific image item, the processor 130, according to certain embodiments of the present disclosure, controls the display module 140 to display high level items or low level items of the specific image item. In certain embodiments, the high level items refer to the items that are configured to include or represent the low level items in a specific layer structure. For example, if the high level items correspond to rock music data as an example of music files, the high level items include the items corresponding to the rock music data, which are classified according to specific criteria (e.g., criteria preconfigured by users or providers, musical classification, or the like).

The processor 130, according to certain embodiments, detects a selection input event with respect to the displayed image item a₁. When a swipe gesture input is detected with respect to the image item a₁, the processor 130 controls the display module 140 to display high level items or low level items of the image item a₁. For example, if the high level item of the image item a₁ is the image item a₀, the processor 130 controls the display module 140 to display the image item a₀ on the screen. For another example, if the low level item of the image item a₁ is the image item a₂, the processor 130 controls the display module 140 to display the image item a₂ on the screen.

The processor 130, according to certain embodiments, controls the display module 140 to display the high level items or the low level items of the image item, on which the swipe gesture input is detected, based on level-based layer structure information on image items that are stored in the memory module 150.

The processor 130, according to certain embodiments, determines whether or not to display the high level item of the image item, on which the swipe gesture input is detected, based on the direction in which the swipe gesture input is detected. For example, when the swipe gesture input is detected in one direction (for example, to the center of the screen, to the left of the screen, or the like) with respect to the area where the image items are displayed, the processor controls the display module 140 to display the low level item of the image item on which the swipe gesture is detected.

For another example, when the swipe gesture input is detected in one direction (for example, to the edge of the screen, to the right of the screen, or the like) with respect to the area where the image items are displayed, the processor controls the display module 140 to display the high level item of the image item on which the swipe gesture is detected. The displaying of the high level item or the low level item according to the direction, in which the swipe gesture input is detected, varies.

According to certain embodiments, when a swipe gesture input is detected on a specific image item, if the high level item or the low level item of the detected image item does not exist, the processor 130 displays a predetermined pop-up window (e.g., a pop-up window “No level item exists”) or a UI showing that the screen is shaking, or outputs a vibration of the electronic device 100 or an audio sound.

The processor 130, according to certain embodiments, controls the display module 140 to display a screen of the low level item that is selected by the selection image item 240. In certain embodiments, the selection image item 240 is an image item for selecting one image item when a plurality of image items is displayed on the screen. For example, in the layer structure “A” that has the low level items of the image item a1 and the image item a₂, the processor 130 identifies the selection of the image item a₂ by detecting the position of the selection image item 240. The processor 130 controls the display module 140 to display a screen corresponding to the selected image item a₂.

The processor 130, according to certain embodiments, detects an input event that moves the selection image item 240. The processor 130 controls the display module 140 to display a screen of the low level items that varies with the detection of the movement of the selection image item 240.

The processor 130 detects an input event that moves the selection image item 240. The processor 130 determines whether the detected moving input event corresponds to the first area where a plurality of image items are displayed or the second area where a screen of the low level items selected by the selection image item 240 is displayed. Based on a result of the determination on the detection of the first area or the second area, the processor 130 determines a low level item that is to be selected after the low level item is selected by the selection image item 240 according to the detection of the movement of the selection image item 240.

For example, the image item a1, the image item a2, the image item a3, the image item a₄, and the image item a₅ are displayed in sequence on the screen. When the selection image item 240 selects the image item a₁ and if the moving input event is detected in the first area, the processor 130 may not select the image item a₂, the image item a₃, and the image item a₄, but selects the image item a₅ according to the detection of the moving input event. In certain embodiments, in the case where the image items are displayed through a circular graphical user interface, the first area is the area outside the circular graphical user interface.

When the selection image item 240 selects the image item a₁, and if the moving input event is detected in the second area, the processor 130 select image item a₁, the image item a₂, the image item a₃, the image item a₄, and the image item a₅ in sequence according to the detection of the moving input event. In certain embodiments, in the case where the image items are displayed through a circular graphical user interface, the second area is the area inside the circular graphical user interface.

The processor 130, according to certain embodiments of the present disclosure, controls the display module 140 to display the image items in a threshold display area of the graphical user interface. In certain embodiments, the threshold display area is the area that is located within a predetermined threshold distance from the graphical user interface in the screen. For example, the processor 130 controls the display module 140 to display the image items along the circumference of the circle of the circular graphical user interface. In certain embodiments, the graphical user interface is not limited to a circular shape and is shaped as a semi-circular, an oval, a triangle, a closed curve, a non-linear form, or the like.

If a swipe gesture input is detected, the processor 130 controls the display module 140 to change the image items, which are displayed in the threshold display area before the swipe gesture input is detected, into the high level item or the low level item of the image item on which the swipe gesture input is detected and to display the same.

The processor 130, according to certain embodiments of the present disclosure, controls the display module 140 to display a graphical user interface having a predetermined shape, such as a circle or a semi-circle, on the screen. For example, the processor 130 controls the display module 140 to display a circular graphical user interface and to display all of the image items within a limited distance range (e.g., the threshold display area) from the circular graphical user interface. If the swipe gesture input is detected on a specific image item, the processor 130 controls the display module 140 to change the image items displayed in the limited distance range (e.g., the threshold display area) into the low level items of the specific image item and to display the same.

The processor 130, according to certain embodiments of the present disclosure, determines whether or not a plurality of level items exist and whether or not all of the plurality of low level items are displayed in the threshold display area when changing the image items into the low level items to be displayed. If it is determined that all of the plurality of low level items cannot be displayed in the threshold display area, the processor 130 determines the priority for the plurality of low level items to be displayed in the threshold display area base on at least one piece of user preference data, update time data, recommendation data, or title data of the plurality of low level items.

In certain embodiments, the user preference data, the update time data, the recommendation data, or the title data of the plurality of low level items is pre-stored in the memory module 150, or is received from an external server (not shown). The processor 130 controls the display module 140 to display the plurality of low level items according to the determined priority.

For example, the processor 130 controls the display module 140 to display the image items related to music on the screen. For example, the processor 130 displays the image items that correspond to the music genre, such as R & B, hip hop, or rock, on the screen.

The processor 130, according to certain embodiments, determines the priority of the image items to be displayed, based on user reproduction history data showing the music data contained in the music genre, which has been reproduced or the music data that is selected in advance according to the user's preference.

The processor 130, according to certain embodiments, identifies the reception time of the music data that is received from the external server (not shown), and determines the priority of the image items to be displayed based on the identified reception time. For example, the processor 130 identifies the reception time of the data corresponding to the image item from the external server (not shown) or the update time thereof on the basis of the time when the swipe gesture input is detected. The processor 130 determines the priority of the plurality of image items to be displayed on the screen based on the reception time of the data corresponding to the image item on which the input event is detected or the update time thereof.

The processor 130, according to certain embodiments, transmits a signal for requesting the image item to be display to the external server (not shown) through the communication module 110. The processor 130 makes a control to display the image item on the screen based on the recommendation data received from the external server (not shown) through the communication module 110.

The processor 130, according to certain embodiments, identifies the title data of the low level items of the image item on which the swipe gesture input is detected. For example, in the case of the title data, such as “About love,” “Forever love,” or “Business for happiness,” the processor 130, based on the initial letters “A,” “F,” and “B,” of the title data, controls the display module 140 to display the title data as “About love,” “Business for happiness,” “Forever love” in alphabetical order.

The processor 130, according to certain embodiments of the present disclosure, detects a touch input event on a specific area in the threshold display area, and if the touch input event reaches a predetermined pop-up display threshold area from the detected area, the processor 130 controls the display module 140 to display a predetermined pop-up item. In certain embodiments, the predetermined pop-up display threshold area varies according to the position of the specific area where the touch input event is detected. For example, the pop-up display threshold area refers to the area where a touch input event is detected in a specific area of the circular graphical user interface and the touch input event moves along the circumference of a circle of the graphical user interface and returns to the specific area where the touch input event has been detected (for example, within the error range of 5%, within the error range of 10%, or the like).

When the processor 130, according to certain embodiments of the present disclosure, controls the display module 140 to display a predetermined pop-up item, the processor 130 controls the display module 140 to display a change-image item that provides a function of changing the image items to be displayed in the threshold display area. For example, the processor 130 makes a control to display a change-image item that provides a function of changing the image items that are currently displayed in a specific area of the screen. In another example, the processor 130 makes a control to resort the image items, which are displayed on the screen on the basis of the recommendation data, based on the title data like (for example, in alphabetical order) or the user frequency data, and to then display the same.

In the case where the processor 130, according to certain embodiments of the present disclosure, controls the display module to display a predetermined pop-up item, the processor 130 controls the display module 140 to display an image item (e.g., a next-image item) that provides a function of displaying the next priority image items following the image items that are displayed in order of the priority in the threshold display area. For example, when the image items of the first priority to the sixth priority, which correspond to the music displayed on the screen, are displayed on the screen among twenty pieces of music data of which the priority has been determined, if an input event for the next-image item is detected, the processor 130 controls the display module 140 to display the image items corresponding to the music data of the 7th priority to the 12th priority.

When an input event for reproducing specific music data is detected, the processor 140, according to certain embodiments, sends a signal for requesting the music data to the external server. When an input event for reproducing specific music data is detected, the processor 140 reproduces the music data through sample reproduction data that is pre-stored in the memory module 150. The processor 140 reproduces the detected music data based on the music data received from the external server while reproducing the sample reproduction data.

The display module 140 displays the information input by the user or the information to be provided to the user as well as various menus of the electronic device 100. That is, the display module 140 provides various screen images necessary for using the electronic device 100, such as a standby screen image, a menu screen image, a message editing screen image, a call screen image, or the like. The display module 140 is implemented by a liquid crystal display (LCD), an organic light emitting diode (OLED), or the like, and is included in the input unit. In addition, the electronic device 100 provides various menu screen images that are displayed based on the display module 140 in accordance with the support of the display module 140.

The display module 140 is provided in the form of a touch screen by being combined with a touch panel. For example, the touch screen is configured to be an integrated module that is made by a combination of the display panel and the touch panel in a laminated structure. The touch panel, for example, detects a user's touch input in at least one of a capacitive type, a pressure-sensitive type, an infrared type, or an ultrasonic type. The touch panel further includes a controller (not shown). Meanwhile, the touch panel in the capacitive type detects the proximity as well as the direct touch input. The touch panel further includes a tactile layer. In certain embodiments, the touch panel provides a tactile reaction to the user. The display module 140, according to certain embodiments, detects the touch input event for requesting the execution of the functions of the electronic device 100. The display module 140 transfers the information corresponding to the detected touch input event to the processor 130.

The display module 140, according to certain embodiments, displays the image items. In certain embodiments, the image items are thumbnail images or icons, which include text data or image data.

The display module 140, according to certain embodiments, displays a selection image item for selecting the low level image items included in each of the image items. For example, when displaying a plurality of image items, the display module 140 displays the selection image item for selecting one image item from among the plurality of image items.

The display module 140, according to certain embodiments, displays the image items in the threshold display area of the graphical user interface. For example, the graphical user interface is formed in various shapes, such as a circle, a semi-circle, a triangle, or the like, and the image items is displayed within a threshold distance from the area of each shape (e.g., a circumference, borders, or the like)

The memory module 150 stores application programs for reproducing various stored files, and a key map or a menu map for operating the display module 140, as well as application programs necessary for the execution of functions according to certain embodiments. In certain embodiments, the key map or the menu map are formed in a variety of forms.

That is, the key map is a keyboard map, a 3*4 key map, or a QWERTY key map, or is a control key map for controlling the operation of the applications that are currently activated. In addition, the menu map is a control key map for controlling the operation of the application programs that are currently activated. In addition, the menu map is a menu map for controlling the operation of the application programs that are currently activated or is a menu map that has various menu items that are provided by the electronic device 100. The memory module 150 includes a program area and a data area.

The program area stores an operating system (OS) for booting the electronic device 100 and operating the elements set forth above, and application programs for reproducing various files, such as an application program for supporting a call function according to the function support of the electronic device 100, a web browser for connecting to the Internet server, an MP3 application program for reproducing other audio sources, an image output application program for reproducing photographs, or a movie reproducing application program.

The data area stores the data that is created according to the use of the electronic device 100, such as phone book information, one or more icons according to a widget function, or various pieces of content. In addition, if the data area is provided in the display module 140, the data area stores user inputs that are received through the display module 140.

The memory module 150, according to certain embodiments of the present disclosure, stores some of the data corresponding to the image items. For example, the memory module 150 stores the sample reproduction data for reproducing the music data in part. In another example, the memory module 150 stores the sample reproduction data having a reproduction time of approximately 5 seconds to 10 seconds with respect to the music data having a reproduction time of 3 minutes 30 seconds.

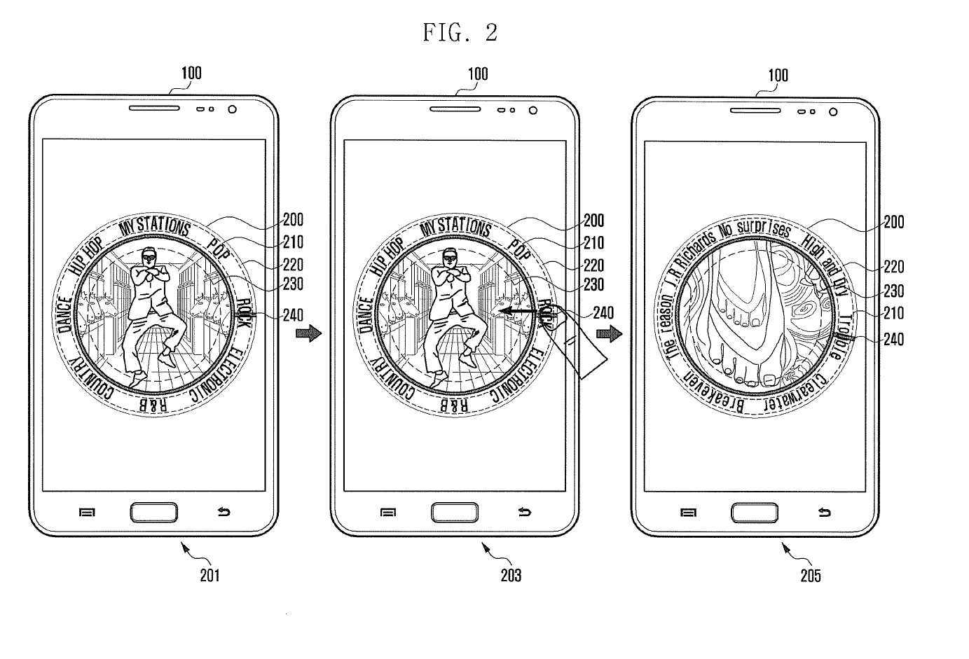

FIG. 2 illustrates a graphical user interface 200 of the electronic device 100 according to various embodiments of the present disclosure.

The electronic device 100 displays the graphical user interface 200 by which the music data is selected through the application that provides a music reproducing service.

Referring to diagram 201, the electronic device 100 displays the music graphical user interface 200. The electronic device 100 displays image items 210 in the threshold display area of the graphical user interface 200. In certain embodiments, the image items 210 is “MY STATIONS,” “POP,” “ROCK,” “ELECTRONIC,” “R & B,” “COUNTRY,” “DANCE,” or “HIP HOP.” The image items 210 displayed in the threshold display area are changed and updated by the user.

The electronic device 100 determines the moving distance or the moving speed of the selection image item 240 based on the position where a movement input event is detected in the screen. For example, when the input event to move the selection image item 240 is detected in a quick moving area 220, the moving distance of the selection image item 240 for selecting the music data is prolonged. For another example, when the moving input event is detected in a slow moving area 230, the moving distance of the selection image item 240 for selecting the music data is shortened.

Referring to diagram 203, the electronic device 100 detects a selection input event for the image item “ROCK.” In certain embodiments, the selection input event is an input signal received from the outside (e.g., a human body, an electronic pen, or the like). The electronic device 100 detects a swipe gesture input after detecting the selection input event for the image item “ROCK.” In certain embodiments, the swipe gesture input refers to the input event that is detected in the first area during a period of time and then released in the second area. The swipe gesture input is not limited to the embodiment above, and can be replaced with a flick input event, a flip input event, or a drag & drop input event.

Referring to diagram 205, the electronic device 100 displays, in the threshold display area of the graphical user interface 200, low level items of the image item “ROCK,” on which the swipe gesture input is detected. In certain embodiments, the low level items of the image item “ROCK” is “Clearwater,” “Breakeven,” “The reason,” “J R Richards,” “No Surprises,” “High and Dry,” “Trouble,” or the like.

If the electronic device 100, according to certain embodiments of the present disclosure, is not able to display all of the low level items contained in the image item “ROCK” in the threshold display area of the graphical user interface 200, the electronic device 100 determines the priority of the image items to be displayed. For example, the electronic device 100 determines the priority for the plurality of low level items to be displayed in the threshold display area based on at least one piece of user preference data, update time data, recommendation data, or title data thereof.

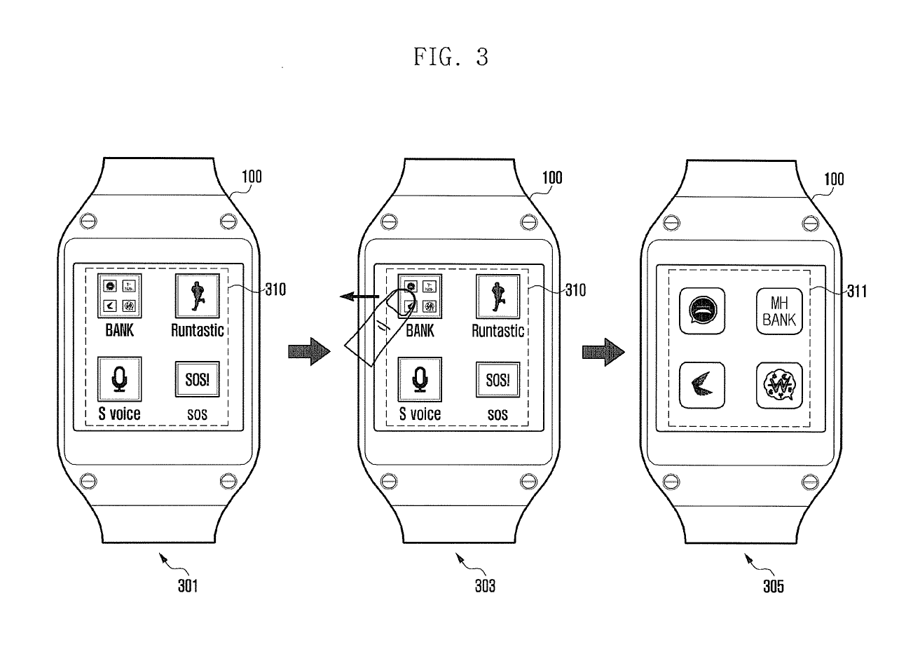

FIG. 3 illustrates a graphical user interface of the electronic device 100 according to various embodiments of the present disclosure.

The electronic device 100, according to certain embodiments of the present disclosure, is a wearable device. The electronic device 100 displays, on the screen 310, applications that provide different services from each other.

Referring to diagram 301, the electronic device 100 displays, on the screen 310, a BANK application for providing banking services, a Runtastic application for providing health-related services, an S-voice application for providing a voice recording service, or an SOS application for providing an emergency call service.

Referring to diagram 303, the electronic device 100 detects a swipe gesture input with respect to the Bank application that provides banking services on the screen 310.

Referring to diagram 305, the electronic device 100 displays, on the screen 311, low level items contained in the Bank application for providing banking services. For example, the Bank application contains an application for providing services of a specific bank, an application for providing exchange rate information, or an application for providing an account book service to the user of the electronic device 100.

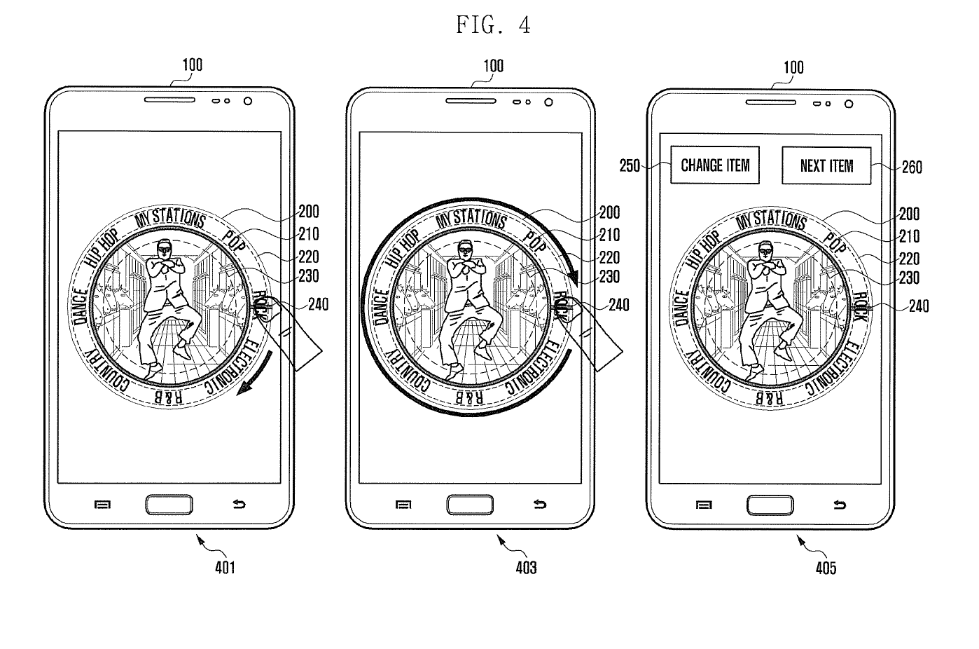

FIG. 4 illustrates a graphical user interface 200 of the electronic device 100 according to various embodiments of the present disclosure.

The electronic device 100 displays the graphical user interface by which the music data is selected through the application to provide a music reproduction service.

Referring to diagram 401, the electronic device 100 displays the music graphical user interface 200. The electronic device 100 displays image items 210 in the threshold display area of the graphical user interface 200. In certain embodiments, the image items 210 is “MY STATIONS,” “POP,” “ROCK,” “ELECTRONIC,” “R & B,” “COUNTRY,” “DANCE,” or “HIP HOP.” The image items 210 displayed in the threshold display area is changed and updated by the user.

Referring to diagram 403, the electronic device 100 detects an input event that makes one revolution along the circumference of the circular graphical user interface 200.

Referring to diagram 405, when the touch input event reaches a predetermined pop-up display threshold area from the detected area, the electronic device 100 displays a predetermined pop-up item. In certain embodiments, the predetermined pop-up display threshold area varies according to the position of the area where the touch input event is detected, or is a specific area in the screen.

According to certain embodiments, when the touch input event makes one revolution from the selection image item 240 for selecting the image item “ROCK,” the electronic device 100 displays a change item 250 and a next item 260. In certain embodiments, the change item 250 provides a function of changing the image items to be displayed in the threshold display area. For example, when an input event for the change item 250 is detected, the processor 130 changes the image items that are currently displayed into the image items that are based on the recommendation data or the user preference data, and displays the same.

The next item 260 provides a function of displaying the next priority items of the image items that are displayed in order of the priority in the threshold display area.

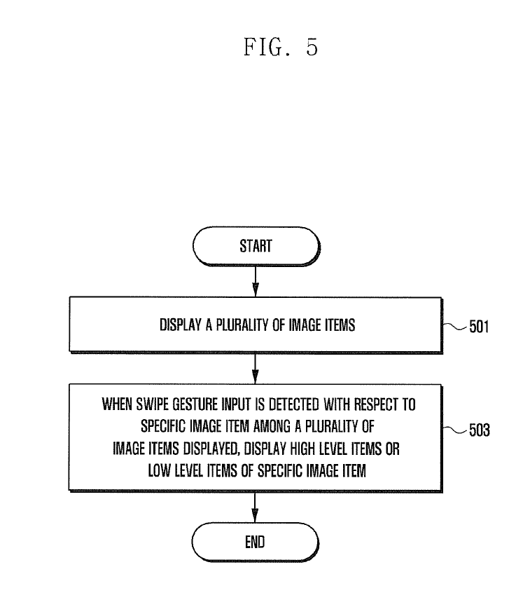

FIG. 5 is a flowchart illustrating the operation of providing the graphical user interface of the electronic device 100 according to various embodiments of the present disclosure.

In step 501, the display module 140 displays a plurality of image items. The image items are thumbnail images or icons, which correspond to specific functions.

In step 503, when a swipe gesture input is detected with respect to a specific image item, the processor 130 displays high level items or low level items of the specific image item. The processor 130, according to certain embodiments, determines whether the high level items or the low level items are to be displayed based on the direction in which the swipe gesture input is detected. For example, when the swipe gesture input is detected to move to the center of the screen, the processor 130 controls the display module 140 to display the low level items of the image item. For another example, when the swipe gesture input is detected to move to the edge of the screen, the processor 130 controls the display module 140 to display the high level items of the image item.

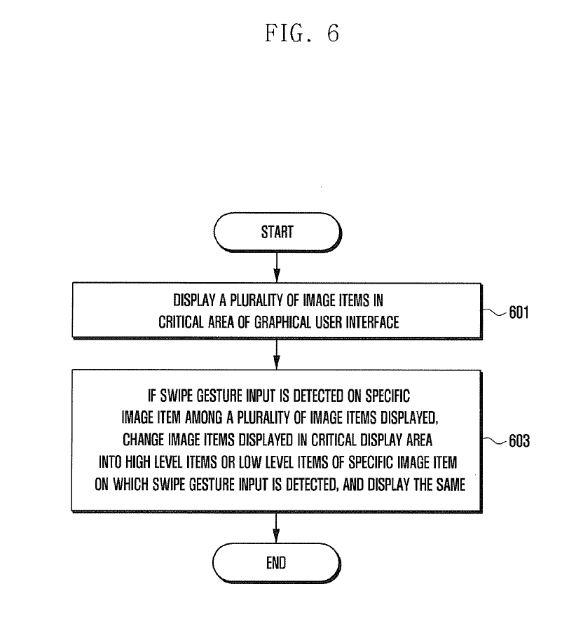

FIG. 6 is a flowchart illustrating the operation of providing a graphical user interface of the electronic device 100 according to various embodiments of the present disclosure.

In step 601, the display module 140 displays a plurality of image items in the threshold area of the graphical user interface. The electronic device 100, according to certain embodiments of the present disclosure, displays a graphical user interface having a predetermined shape and displays the image items within a threshold distance from the displayed graphical user interface. In certain embodiments, the graphical user interface is shaped into a circle, a semi-circle, a triangle, a closed curve, or the like.

In step 603, if a swipe gesture input is detected on a specific image item among a plurality of image items displayed, the processor 130 changes the image items displayed in the threshold display area into the high level items or the low level items of the specific image item on which the swipe gesture input has been detected and displays the same.

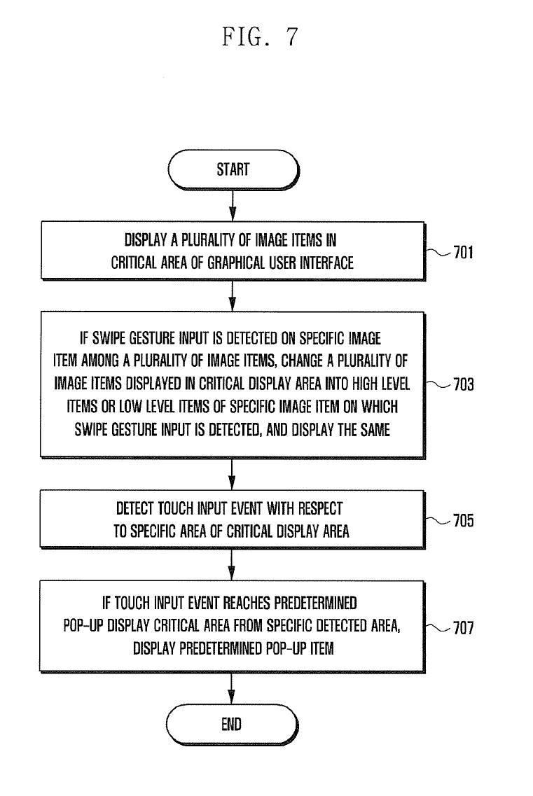

FIG. 7 is a flowchart illustrating the operation of providing a graphical user interface of the electronic device 100 according to various embodiments of the present disclosure.

In step 701, the display module 140 displays a plurality of image items in the threshold area of the graphical user interface. The electronic device 100, according to certain embodiments of the present disclosure, displays a graphical user interface having a predetermined shape and displays the image items within a threshold distance from the displayed graphical user interface.

In step 703, if a swipe gesture input is detected on a specific image item, the processor 130 controls the display module 140 to change the image items displayed in the threshold display area into the high level items or the low level items of the specific image item on which the swipe gesture input has been detected, and to display the same.

In step 705, the processor 130 detects a touch input event with respect to a specific area of the threshold display area.

In step 707, if the touch input event reaches a predetermined pop-up display threshold area from the detected area, the processor 130 controls the display module 140 to display a predetermined pop-up item.

When the processor 130, according to certain embodiments of the present disclosure, controls the display module 140 to display a predetermined pop-up item, the processor 130 displays a change-image item that provides a function of changing the image items to be displayed in the threshold display area. The processor 130, according to certain embodiments of the present disclosure, displays at least one item using the next-image item that provides a function of displaying the next priority image items following the image items that are displayed in order of the priority in the threshold display area.

The above described components of the electronic device, according to various embodiments of the present disclosure, are formed of one or more components, and a name of a corresponding component element is changed based on the type of electronic device. The electronic device, according to the present disclosure, includes one or more of the aforementioned components or further includes other additional components, or some of the aforementioned components can be omitted. Further, some of the components of the electronic device according to the various embodiments of the present disclosure are combined to form a single entity, and thus, equivalently execute functions of the corresponding elements prior to the combination.

The “module” used in various embodiments of the present disclosure refer to, for example, a “unit” including one of hardware, software, and firmware, or a combination of two or more of the hardware, software, and firmware. The “module” is interchangeable with a term, such as a unit, a logic, a logical block, a component, or a circuit. The module is a minimum unit of an integrated component element or a part thereof. The “module” is the smallest unit that performs one or more functions or a part thereof. The module is mechanically or electronically implemented. For example, the “module” according to various embodiments of the present disclosure includes at least one of an application-specific integrated circuit (ASIC) chip, a field-programmable gate arrays (FPGAs), and a programmable-logic device for performing operations which have been known or are to be developed hereafter.

According to various embodiments, at least some of the devices (e.g., modules or functions thereof) or methods (e.g., operations) according to the various embodiments of the present disclosure are implemented as, for example, instructions stored computer readable storage media in the form of programming modules. When the command is executed by one or more processors (for example, the processor 160), the one or more processors execute a function corresponding to the command. The computer-readable storage medium can, for example, be the storage module 130. At least some of the programming modules are implemented (for example, executed) by, for example, the processor 160. At least a part of the programming module can, for example, include a module, a program, a routine, a set of instructions, or a process for performing at least one function.

The computer readable recording medium includes magnetic media such as a hard disc, a floppy disc, and a magnetic tape, optical media such as a compact disc read only memory (CD-ROM) and a digital versatile disc (DVD), magneto-optical media such as a floptical disk, and hardware devices specifically configured to store and execute program commands, such as a read only memory (ROM), a random access memory (RAM), and a flash memory. In addition, the program instructions include high class language codes, which are executed in a computer by using an interpreter, as well as machine codes made by a compiler. The aforementioned hardware device is configured to operate as one or more software modules in order to perform the operation of various embodiments of the present disclosure, and vice versa.

A module or a programming module according to the present disclosure includes at least one of the described component elements, a few of the component elements is omitted, or additional component elements is included. Operations executed by a module, a programming module, or other component elements, according to various embodiments of the present disclosure, are executed sequentially, in parallel, repeatedly, or in a heuristic manner. Further, some operations are executed according to another order or are omitted, or other operations are added.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
a display module configured to display a plurality of image items; and
a processor configured to control the display module to display high level items or low level items of an image item if a swipe gesture input with respect to the image item among the plurality of image items is detected.

2. The electronic device of claim 1, wherein the display module is further configured to display a selection image item for selecting the low level item of each of the plurality of image items, and
the processor is further configured to control the display module to display the low level item selected through the selection image item on a screen.

3. The electronic device of claim 2, wherein the display module is further configured to:
display the plurality of image items in the first area, and
display the low level item selected through the selection image item in the second area, and
the processor is further configured to:
detect an input event that moves the selection image item;
determine whether the input event is detected in the first area or in the second area; and
based on a result of the determination on the detection of the first area or the second area, determine the low level item that is to be selected after the low level item that has been selected through the selection image item in response to the detection of the movement of the selection image item.

4. The electronic device of claim 1, wherein the display module is further configured to display the plurality of image items in a threshold display area of a graphical user interface, and
the processor configured to:
control the display module to change the plurality of image items, which have been displayed in the threshold display area before the swipe gesture input is detected, into high level items or low level items of the image item on which the swipe gesture input image is detected, and
display the high level items or the low level items of the image item on which the swipe gesture input image is detected.

5. The electronic device of claim 4, wherein if the changed and displayed items are a plurality of low level items and if all of the plurality of low level items are not able to be displayed in the threshold display area, the processor is further configured to:
determine the priority for the plurality of low level items to be displayed in the threshold display area base on at least one piece of user preference data, update time data, recommendation data, or title data of the plurality of low level items, and
control the display module to display the plurality of low level items in the threshold display area according to the determined priority.

6. The electronic device of claim 5, wherein the processor is further configured to:
detect a touch input event with respect to a specific area in the threshold display area, and
if the touch input event reaches a predetermined pop-up display threshold area from the detected area, control the display module to display a predetermined pop-up item.

7. The electronic device of claim 6, wherein, in the case where the processor controls the display module to display the predetermined pop-up item, the processor is further configured to controls the display module to display at least one of a change-image item that provides a function of changing image items to be displayed in the threshold display area or a next-image item that provides a function of displaying the next priority image items following the image items that are displayed in order of the priority in the threshold display area.

8. The electronic device of claim 5, further comprising a communication module configured to:
transmit a signal for requesting the recommendation data to an external server, and
receive the recommendation data from the external server in response to the request signal.

9. The electronic device of claim 4, wherein the graphical user interface has one of the shape of a circle, a semi-circular, an oval, or a non-linear curve.

10. The electronic device of claim 1, wherein to display the high level items or the low level items of the image item on which the swipe gesture input is detected is a function of a level-based layer structure information on the plurality of image items.

11. A method for displaying a graphical user interface in an electronic device, the method comprising:
displaying, via a display module, a plurality of image items; and
controlling, via a processor, the display module to display high level items or low level items of an image item when a swipe gesture input with respect to the image item among the plurality of image items is detected.

12. The method of claim 11, further comprising:
displaying, via the display module, a selection image item for selecting the low level item of each of the plurality of image items; and
controlling, via the processor, the display module to display the low level item selected through the selection image item on a screen.

13. The method of claim 12, further comprising:
displaying, via the display module, the plurality of image items in the first area;
displaying, via the display module, the low level item selected through the selection image item in the second area;
detecting, via the processor, an input event that moves the selection image item;
determining, via the processor, whether the input event is detected in the first area or in the second area; and
determining the low level item that is to be selected after the low level item that has been selected through the selection image item in response to the detection of the movement of the selection image item based on the result of the determination on the detection of the first area or the second area.

14. The method of claim 11, wherein displaying the plurality of image items comprises:
displaying the plurality of image items in a threshold display area of a graphical user interface;
controlling the display module to display high level items or low level items of the specific image item comprises letting the processor control the display module to change the plurality of image items, which have been displayed in the threshold display area before the swipe gesture input is detected, into high level items or low level items of the image item on which the swipe gesture input image is detected, and
displaying the high level items or the low level items of the image item on which the swipe gesture input image is detected.

15. The method of claim 14, further comprising:
if the changed and displayed items are a plurality of low level items and if all of the plurality of low level items are not able to be displayed in the threshold display area, determining the priority for the plurality of low level items to be displayed in the threshold display area based on at least one piece of user preference data, update time data, recommendation data, or title data of the plurality of low level items; and
controlling the display module to display the plurality of low level items in the threshold display area according to the determined priority.

16. The method of claim 15, further comprising:
detecting a touch input event with respect to a specific area in the threshold display area; and
if the touch input event reaches a predetermined pop-up display threshold area from the detected area, controlling the display module to display a predetermined pop-up item.

17. The method of claim 16, wherein controlling the display module to display a predetermined pop-up item comprises letting the processor control the display module to display at least one of a change-image item that provides a function of changing image items to be displayed in the threshold display area or a next-image item that provides a function of displaying the next priority image items following the image items that are displayed in order of the priority in the threshold display area.

18. The method of claim 15, further comprising;
transmitting, via a communication module, a signal for requesting the recommendation data to an external server; and
receiving, via the communication module, the recommendation data from the external server in response to the request signal.

19. The method of claim 14, wherein the graphical user interface has one of the shape of a circle, a semi-circular, an oval, or a non-linear curve.

20. The electronic device of claim 11, wherein displaying the high level items or the low level items of the image item on which the swipe gesture input is detected is a function of a level-based layer structure information on the plurality of image items.
